(19) United States
(12) Patent Application Publication
(10) Pub. No.: US 2008/0136778 A1
(43) Pub. Date: Jun. 12, 2008

(54) MOUSE DEVICE FOR A COMPUTER

(76) Inventor: Eli Hursh, Corona, CA (US)

Correspondence Address: Eli Hursh, 7877 Hazelnut Dr., Corona, CA, 92880, US

(21) Appl. No.: 11/950,316

(22) Filed: Dec. 4, 2007

Related U.S. Application Data
(60) Provisional application No. 60/868,591, filed on Dec. 5, 2006.

(51) Int. Cl. G06F 3/033

(52) U.S. Cl. 345/164

(57) ABSTRACT

An apparatus for a mouse device includes a body including a generally cylindrical shape and configured to fit in a palm of a user's hand. A track ball is positioned at an end of the body. A scroll knob is positioned circumferentially of the track ball. Click buttons are positioned on a surface of the body. A battery pack is attached to the body for powering internal functions of the apparatus. A glove is attached to the body where when the user's hand is placed in the glove the track ball and scroll knob are easily accessible by the thumb, the click buttons are easily accessibly by the fingers and the apparatus is retained on the user's hand when the user's hand is used for key entry on the keyboard.

### CROSS-REFERENCE TO RELATED APPLICATIONS

The present Utility patent application claims priority benefit of the U.S. provisional application for patent Ser. No. 60/868,591 filed on Dec. 5, 2006 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to mouse devices for use with a computer. More particularly, the invention relates to a mouse device that can be attached to a user hand to greatly reduce repetitive wrist motion and allow the user to perform keyboard entry with the device attached.

### BACKGROUND OF THE INVENTION

An individual is working at their desk, trying to ignore the tingling or numbness they've had for months in a hand and wrist. Suddenly, a sharp, piercing pain shoots through the wrist and up their arm. More than likely the individual may have carpal tunnel syndrome (CTS), a painful progressive condition caused by compression of a key nerve in the wrist. Carpal tunnel syndrome occurs when the median nerve, which runs from the forearm into the hand, becomes pressed or squeezed at the wrist. The median nerve controls sensations to the palm side of the thumb and fingers, although not the little finger, as well as impulses to some small muscles in the hand that allow the fingers and thumb to move. The carpal tunnel, a narrow, rigid passageway of ligament and bones at the base of the hand, houses the median nerve and tendons. Sometimes, thickening from irritated tendons or other swelling narrows the tunnel and causes the median nerve to be compressed. The result may be pain, weakness, or numbness in the hand and wrist, radiating up the arm. Although painful sensations may indicate other conditions, carpal tunnel syndrome is the most common and widely known of the entrapment neuropathies in which the body's peripheral nerves are compressed or traumatized.

CTS is a very common problem affecting many types of workers in different settings, both in the service industry and manufacturing. In 2004, the Bureau of Labor Statistics reported that CTS caused the greatest number of missed workdays −43 days for those who have the problem. More workdays were missed due to CTS than broken bones or back injury.

Repetitive motion injury that leads to CTS is usually the result of overuse, from bending the wrist repeatedly or keeping it flexed without rest. With repeated stress, the tissue that lines tendons, synovium, fills with fluid and swells in response to injury. Inflammation of soft tissue leaves even less room in this already tight tunnel.

Wrist straining tasks that can lead to CTS include working a cash register, use of vibrating machinery, such as power tools, any recreation that involves repetitive bending of the wrist, such as knitting and racquetball, golf and canoeing and working at a computer. Improper use of the mouse is more of a cause than typing.

The American Academy of Orthopedic Surgeons (AAOS) as part of the Prevent Injuries America Program urged that prevention is a first line of defense against carpal tunnel syndrome. Specifically, the AAOS offered the following advice:
Avoid activities requiring excessive up-and-down and side-to-side movements of the wrist.
Position and align your hands properly while working. Wrists should be parallel and elbows should be at a 90-degree angle to your work surface, i.e. desk or keyboard.
Take frequent breaks to stand, walk, and stretch.
Ask your orthopedic surgeon about splints to limit wrist movement.
Avoid direct pressure on the heel of the hand.
Don't wear restrictive watchbands/jewelry or clothing with tight elastic sleeves.
Learn proper use of the computer mouse.

It is recommended that, when using a mouse, the user:
Use the mouse with an open, relaxed hand posture.
Don't grip the mouse between the thumb and little finger.
Use the entire arm to move the mouse as opposed to shifting it with a side-to-side wrist motion.
Do not use a wrist rest.
Keep the mouse close to the keyboard.

In view of the above recommendations, it becomes readily apparent that the standard computer mouse design is not ergonomically designed. The way a mouse is typically used may lead to repetitive motion injury and contribute to CTS.

In response to the growing CTS issues, many computer manufacture and manufacturers of computer accessories are developing and introducing ergonomically designed keyboards and pointing devices, mouse devices. Some keyboards incorporate pointing devices into the keyboard, such as track balls, touch pads or joy sticks. These designs keep the mouse close to the keyboard, but may not effectively reduce repetitive wrist motion. Users who do heavy screen navigation and little keyboard entry may find these designs cumbersome and not very intuitive to use. Designs for mouse devices have incorporated track balls, touch pads and joy sticks in an attempt to change the motion of a user's wrist. These designs may not effectively reduce repetitive wrist motion and those suffering from CTS may still find them painful to use. Other mouse devices have been observed that utilize motion detectors and don't require a flat surface for operation. These may reduce wrist motion at the expense of excessive tiring arm motions. Use of these devices along with keyboard entry is very cumbersome, as the devices must be constantly picked up then placed back on a surface when key entry is required.

In view of the foregoing, there is a need for mouse device that greatly reduces or eliminates repetitive wrist motion, is intuitive to use and can be used effectively with keyboard entry.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a side view of an exemplary mouse device, in accordance with an embodiment of the present invention;

FIG. 2 illustrates a perspective view of an exemplary mouse device, in accordance with an embodiment of the present invention;

FIG. 3 illustrates a side view of an exemplary mouse device, in accordance with an embodiment of the present invention with the attachment means released;

FIG. 4 illustrates a side view of an exemplary mouse device, in accordance with an embodiment of the present invention positioned in a user's hand;

FIG. 5 illustrates a side view of an exemplary mouse device, in accordance with an embodiment of the present invention with the battery pack detached from the body; and

FIG. 6 illustrates a base unit for recharging the battery pack, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a mouse device for a computer is presented.

In one embodiment, an apparatus for a mouse device for a computer having a display and a keyboard is presented. The apparatus includes a body including a generally cylindrical shape and configured to fit in a palm of a user's hand. A track ball is positioned at an end of the body and accessible by a thumb of the user's hand for controlling positioning of a cursor on the display. A scroll knob is positioned circumferentially of the track ball and accessible by the thumb for providing a scroll function on the display. Click buttons are positioned on a surface of the body and accessible by fingers of the hand for providing right and left click functions. A battery pack is attached to the body for powering internal functions of the apparatus. A glove is attached to the body including a thumb hole and a fingers hole where when the user's hand is placed in the glove by placing the thumb in the thumb hole and the fingers through the fingers hole such that the body is retained against the palm, the track ball and scroll knob are easily accessible by the thumb, the click buttons are easily accessibly by the fingers and the apparatus is retained on the user's hand when the user's hand is used for key entry on the keyboard. In another embodiment, the glove further includes an adjustable attachment means for adjustably attaching the glove to the user's hand. In other embodiments, the body further includes contoured surfaces for fitting against the palm and under the fingers and the battery pack further includes contoured surfaces for fitting in the hand. In further embodiments the body further includes direction buttons accessible by the fingers and at least programmed for navigating screens on the display and the direction buttons are programmed for controlling applications on the computer. In other embodiments the apparatus connects to the computer by in part a wireless connection where a first part of the wireless connection is contained within the body and powered by the battery pack and further including a base unit including a second part of the wireless connection, the base unit connected to the computer. In still other embodiments, the battery pack is detachable from the base and the base unit further includes a first receptacle for charging the battery pack, the battery pack further includes indicator lights for indicating an amount of charge in the battery pack and the base unit further includes a second receptacle for charging a spare battery pack.

In another embodiment an apparatus for a mouse device for a computer having a display and a keyboard is presented. The apparatus includes means for a body to fit in a palm of a user's hand, means for controlling positioning of a cursor on the display, means for providing a scroll function on the display, means for providing right and left click functions, means for powering internal functions of the apparatus and means for retaining the body against the palm where the positioning means, the scroll function means and the click functions means are easily accessible and the apparatus is retained on the user's hand when the user's hand is used for key entry on the keyboard. In another embodiment, the retaining means further includes an adjustable attachment means for adjustably attaching the retaining means to the user's hand. Other embodiments further include means for providing direction buttons and means for providing a first part of a wireless connection to the computer. Still other embodiments further include means for providing a second part of the wireless connection to the computer, means for charging the powering means and means indicating the charge on the powering means.

In another embodiment an apparatus for a mouse device for a computer having a display and a keyboard is presented. The apparatus includes a body including a generally cylindrical shape and contoured surfaces for fitting against a palm and under fingers of a user's hand. A track ball is positioned at an end of the body and accessible by a thumb of the user's hand for controlling positioning of a cursor on the display. A scroll knob is positioned circumferentially of the track ball and accessible by the thumb for providing a scroll function on the display. Click buttons are positioned on a surface of the body and accessible by fingers of the hand for providing right and left click functions. A battery pack is attached to the body for powering internal functions of the apparatus and including contoured surfaces for fitting in the hand and indicator lights for indicating an amount of charge in the battery pack. A glove is attached to the body including a thumb hole, a fingers hole and an adjustable attachment means for adjustably attaching the glove to the user's hand, where when the user's hand is placed in the glove by placing the thumb in the thumb hole and the fingers through the fingers hole such that the body is retained against the palm, the track ball and scroll knob are easily accessible by the thumb, the click buttons are easily accessibly by the fingers, repetitive wrist motions are substantially eliminated and the apparatus is retained on the user's hand when the user's hand is used for key entry on the keyboard. Yet another embodiment further includes a base unit for charging the battery pack.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

The present invention, Thumb-Tak Mouse, is a handheld mini computer mouse designed to reduce the causes and effects of carpal tunnel syndrome in frequent computer users. The hand-sized mouse is fitted onto a partial, reversible glove designed for use by right or left-handed individuals. This glove attaches to the hand with an adjustable fastening material that is easy to attach and remove. The mouse is easy to handle and encourages comfort in use. The top portion of the mouse has an adjustable and easy to move tracking ball with rotating scroll knob activated by the thumb. Similar to the standard computer mouse, this unit also has buttons enabling the right click and left click. These buttons can be activated with the fingers. A back button and a forward button are also included on the mouse for added convenience. In a preferred embodiment, the mouse is 4 to 4½ inches long. The mouse has a removable, rechargeable battery in the base of the system. This battery, in addition to a back-up battery, can be placed in a base unit for recharging. The charging base has a retractable power cord. In other preferred embodiments, the mouse and charging base feature lights that indicate the amount of remaining battery power. Embodiments of the present invention may be connected to the computer by either a wired connection or a wireless connection. The present invention may be used with a computer or computing device accepting a pointing device input. The present invention may be adjusted or adapted for any size hand. The slim design and attachment means of the present invention allow users to operate the keyboard while using this mouse.

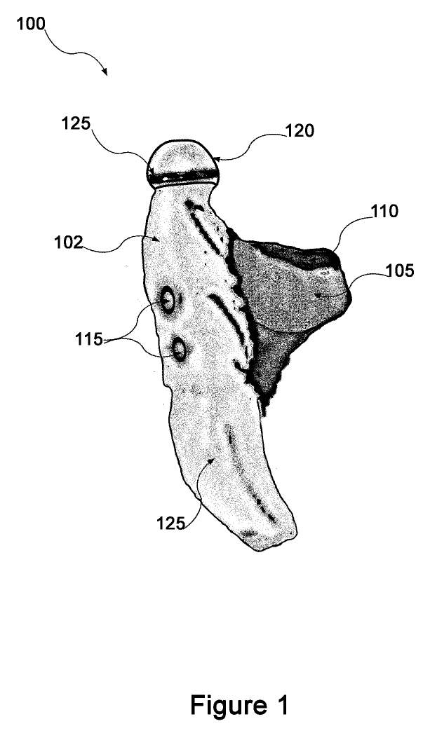

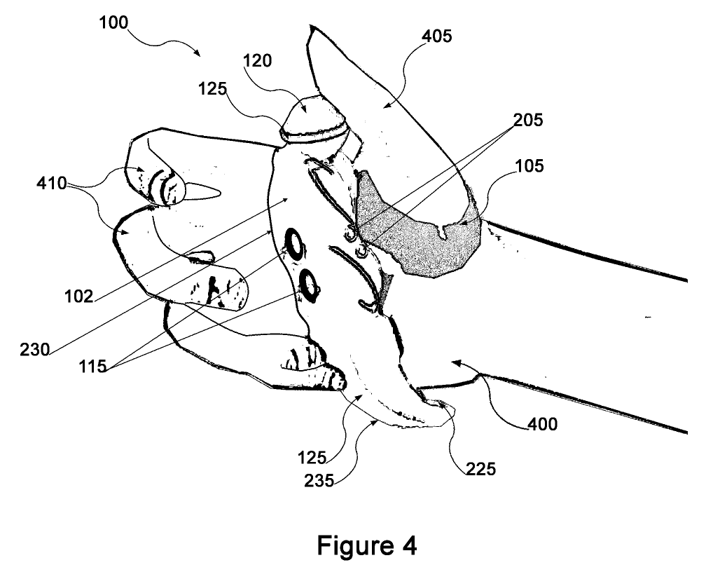

FIG. 1 illustrates a side view of an exemplary mouse device, in accordance with an embodiment of the present invention. Mouse device 100 has a generally cylindrical shape body 102. Glove 105 is attached to a surface of body 102. In a preferred embodiment of the present invention, glove 105 is removably attached to body 102 and is reversible for use by right or left-handed users. In other embodiments, the glove is adhesively attached to the body. Glove 105 has a thumb opening 110 for accepting a user's thumb 405, shown in FIG. 4. Buttons 115 provide left and right click functions associated with using a mouse. Buttons 115 are easily accessible by a user's fingers 410, shown in FIG. 4, when the user's hand is properly positioned in the glove. Track ball 120 is positioned at the top of body 102 to provide the cursor movement associated with moving a standard mouse. Track ball 120 is easily rotated in any direction by the user's thumb. In some embodiments the track ball is adjustable to accommodate different size thumbs. The Trackball moves from side to side. Positioned proximate the track ball is scroll knob 125. Scroll knob 125 is easily accessible to the user's thumb for rotating either left or right to perform the scroll function associated with the standard mouse. In other embodiments scroll knob 125 may include a switch, which is engaged when a side of the scroll knob is pressed, to activate the third button click associated with some standard mouse devices. Removable battery pack 125 is positioned on a bottom portion of the body 102 and on an opposite side of the glove 105. In other embodiments the battery pack may be positioned on the same side as the glove or on a side adjacent to the glove.

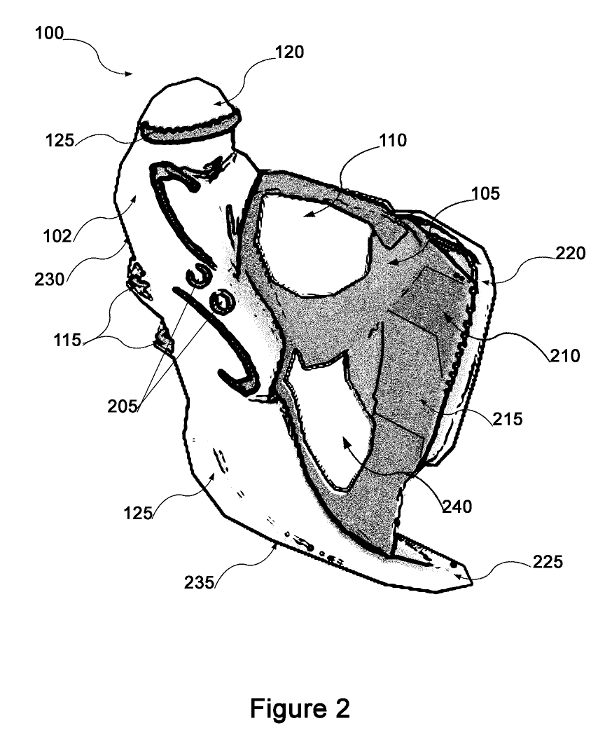

FIG. 2 illustrates a perspective view of an exemplary mouse device, in accordance with an embodiment of the present invention. In this embodiment, direction buttons 205 are provided on body 102. These buttons may be programmed for the back and forward functions associated with most browser applications. In other embodiments the buttons may be programmed for other functions such as, but not limited to, stop, refresh, home and print. In this embodiment, glove 105 has an adjustable attachment means 210 and 215 for attaching to the user's hand. In a preferred embodiment the attachment means is a hook and loop type. In other embodiments the attachment means may be, but not limited to, straps and buckles, buttons and holes, snaps or any other type of adjustable means. It is also contemplated that an elastic material that would stretch to fit the user's hand may replace the attachment means. Pad 220 is attached to back side of glove 105. This pad is a generally soft material and provides a space where information can be displayed. This information could be, but not limited to, model of the mouse device, company logo, company name or any other information that is desired to present to the user. In further embodiments, this pad may be customizable by users where users could apply information, such as, but not limited to, graphic designs, pictures, names or any message. Inside surface 225 is curved and shaped to comfortably fit in the palm of the user's hand when the hand is placed through hand opening 240 and the thumb is placed in thumb opening 110. This allows body 102 to fit closely to the user's palm without any discomfort for long periods of time. Similarly, outside surface 230 and battery pack surface 235 are curved and shaped to fit comfortably under the user's fingers. In other embodiments surfaces 225, 230 and 235 may have a texture that makes the body 102 easy to handle and pleasant to the touch.

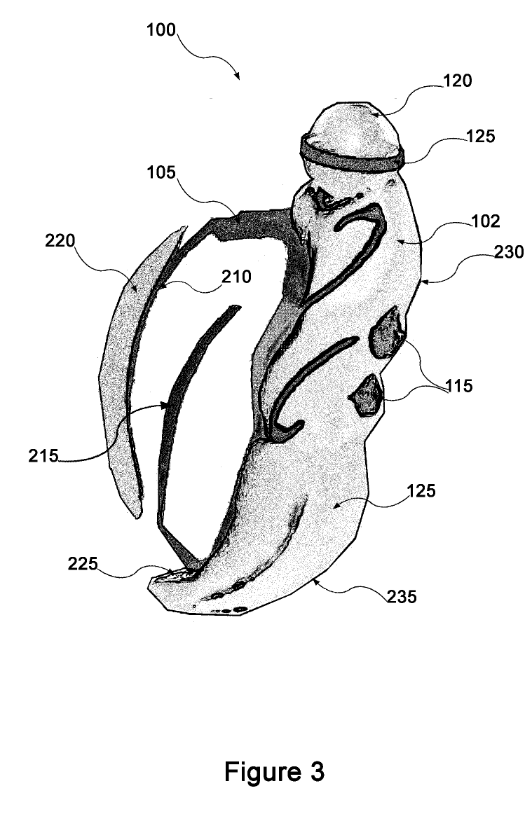

FIG. 3 illustrates a side view of an exemplary mouse device, in accordance with an embodiment of the present invention with the attachment means released. As illustrated, attachment elements 210 and 215 are separated. In the preferred embodiment elements 210 and 215 form a hook and loop attachment means.

FIG. 4 illustrates a side view of an exemplary mouse device, in accordance with an embodiment of the present invention positioned in a user's hand. In the embodiment shown, mouse device 100 is configured for use with a right hand 400. In other embodiments glove 105 is reversed for left handed use. Thumb 405 is inserted through thumb hole 110, FIG. 1, and attachment means 210 and 215, FIG. 2, on the back of hand 400, secure the mouse device to the hand with body 102 resting against the palm of hand 400. With the mouse device 100 properly secured to hand 400, thumb 405 easily engages track ball 120 and scroll knob 125. Fingers 410 may easily engage buttons 115 and 205. When buttons 115 are programmed for right and left click functions, using these buttons with fingers 410 is easy and intuitive for users familiar with a standard mouse. When mouse device 100 is properly attached to hand 400, curved surfaces 225, 230 and 235 fit comfortably against the user's hand. Track ball 120, scroll knob 125, and buttons 115 and 205 can be operated without movement the user's wrist. This substantially eliminates repetitive wrist motion, which may lead to CTS. For users who are suffering from CTS, embodiments of the present invention may be comfortably used with little or no additional pain. In other embodiments, the glove may be enlarged to include a wrist support for users that may require restricted movement of the wrist. This support would not interfere with the operation of the present invention. Since mouse device 100 is securely attached to the user's hand, the user can easily use this hand for keyboard entry without having to remove the mouse device. Thus the user can quickly and efficiently go back and forth between keyboard entry and screen navigation without the hand leaving a basic position for typing or keyboard entry.

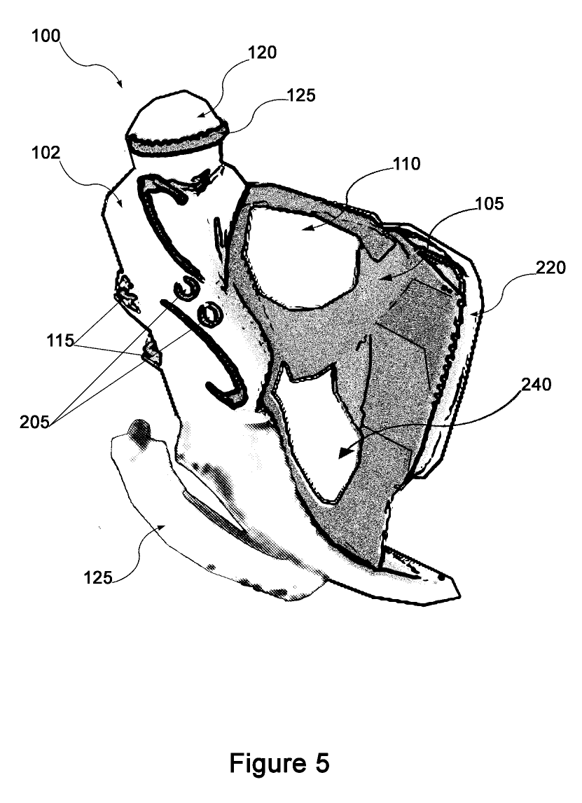

FIG. 5 illustrates a side view of an exemplary mouse device, in accordance with an embodiment of the present invention with the battery pack detached from the body. In a preferred embodiment, battery pack 125 may be quickly detached from body 102 for replacement with a fully charged battery pack without removing the glove from the hand.

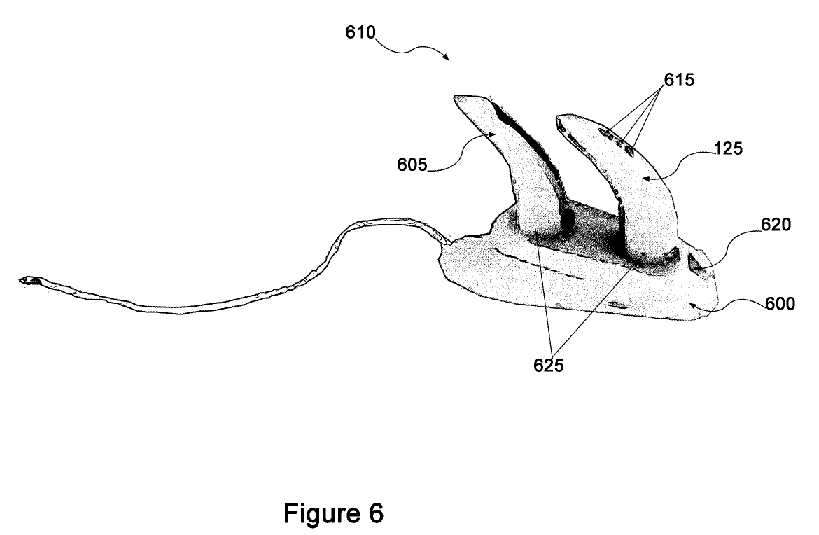

FIG. 6 illustrates a base unit for recharging the battery pack, in accordance with an embodiment of the present invention. Base unit 600 has receptacles 625 where battery pack 125 may be placed for recharging. Indicator lights 615 on battery pack 125 indicate the status of the charge in the battery. Base unit light 620, indicates the status of the base unit 600. Light 620 may indicate, for example, but not limited to, that the base unit is connected to a power source via cord 610, the battery pack is being charged or the base unit has completed charging the battery pack. It will be readily apparent to one skilled in the art that indicator light can be configured for various types of status indication. In FIG. 6, a spare backup battery pack 605 is shown. Other embodiments may not have a spare backup battery pack of may have more than one. As such, base unit 600 may have just one receptacle or numerous receptacles. In a preferred embodiment of the present invention, mouse device 100 is configured for wireless connection and base unit 600 is configured to receive the wireless connection from mouse device 100 and communicate with a computer using cord 610. Base unit 600 may also communicate status information to the computer regarding the charge on the battery packs in the receptacles. In other embodiments, the base unit may also communicate status information to the computer regarding the charge on battery pack 125 attached to body 102. An application program running on the computer may provide the user with information regarding the status of battery pack 125 and spare backup battery pack 605. The application program may also be configured to issue an alert or alarm to the user when the charge on battery pack 125, attached to body 102, is low and needs to be replaced with a charged battery pack. In some embodiments cord 610 may connect directly to the computer and, if a communication port on the computer is configured to supply power, use power from the computer to charge the battery pack. In other embodiments, if the communication port cannot supply power, an additional connector is attached to cord 610 for connection to a suitable power source. In other embodiments, power is supplied to the base unit via a connector, not shown, on the base unit and power does not flow through cord 610. In a preferred embodiment of the present invention, cord 610 is retractable. This allows for a portion or all of cord 610 to be retracted into the base unit 600 such that only length of cord needed to make the connection is exposed.

Having fully described at least one embodiment of the present invention, other equivalent or alternative methods of implementing a mouse device, according to the present invention, will be apparent to those skilled in the art. The invention has been described above by way of illustration, and the specific embodiments disclosed are not intended to limit the invention to the particular forms or components disclosed therein. The invention is thus to cover all modifications, equivalents, and alternatives falling within the spirit and scope of the following claims.

What is claimed is:

1. An apparatus for a mouse device for a computer having a display and a keyboard, the apparatus comprising:
a body comprising a generally cylindrical shape and configured to fit in a palm of a user's hand;
a track ball positioned at an end of said body and accessible by a thumb of said user's hand for controlling positioning of a cursor on the display;
a scroll knob positioned circumferentially of said track ball and accessible by said thumb for providing a scroll function on the display;
click buttons positioned on a surface of said body and accessible by fingers of said hand for providing right and left click functions;
a battery pack attached to said body for powering internal functions of the apparatus; and
a glove attached to said body comprising a thumb hole and a fingers hole where when said user's hand is placed in said glove by placing said thumb in said thumb hole and said fingers through said fingers hole such that said body is retained against said palm, said track ball and scroll knob are easily accessible by said thumb, said click buttons are easily accessibly by said fingers and the apparatus is retained on said user's hand when said user's hand is used for key entry on the keyboard.

2. The apparatus as recited in claim 1, wherein said glove further comprises an adjustable attachment means for adjustably attaching said glove to said user's hand.

3. The apparatus as recited in claim 2, wherein said body further comprises contoured surfaces for fitting against said palm and under said fingers.

4. The apparatus as recited in claim 3, wherein said battery pack further comprises contoured surfaces for fitting in said hand.

5. The apparatus as recited in claim 1, wherein said body further comprises direction buttons accessible by said fingers and at least programmed for navigating screens on the display.

6. The apparatus as recited in claim 5, wherein said direction buttons are programmed for controlling applications on the computer.

7. The apparatus as recited in claim 4, wherein the apparatus connects to the computer by in part a wireless connection where a first part of said wireless connection is contained within said body and powered by said battery pack.

8. The apparatus as recited in claim 7, further comprising a base unit comprising a second part of said wireless connection, said base unit connected to the computer.

9. The apparatus as recited in claim 8, wherein said battery pack is detachable from said base and said base unit further comprises a first receptacle for charging said battery pack.

10. The apparatus as recited in claim 9, wherein said battery pack further comprises indicator lights for indicating an amount of charge in said battery pack.

11. The apparatus as recited in claim 9, wherein said base unit further comprises a second receptacle for charging a spare battery pack.

12. An apparatus for a mouse device for a computer having a display and a keyboard, the apparatus comprising:
means for a body to fit in a palm of a user's hand;
means for controlling positioning of a cursor on the display;
means for providing a scroll function on the display;
means for providing right and left click functions;
means for powering internal functions of the apparatus; and
means for retaining said body against said palm where said positioning means, said scroll function means and said click functions means are easily accessible and the apparatus is retained on said user's hand when said user's hand is used for key entry on the keyboard.

13. The apparatus as recited in claim 12, wherein said retaining means further comprises an adjustable attachment means for adjustably attaching said retaining means to said user's hand.

14. The apparatus as recited in claim 12, further comprising means for providing direction buttons.

15. The apparatus as recited in claim 12, further comprising means for providing a first part of a wireless connection to the computer.

16. The apparatus as recited in claim 15, further comprising means for providing a second part of said wireless connection to the computer.

17. The apparatus as recited in claim 16, further comprising means for charging said powering means.

18. The apparatus as recited in claim 17, further comprising means indicating the charge on said powering means.

19. An apparatus for a mouse device for a computer having a display and a keyboard, the apparatus comprising:
a body comprising a generally cylindrical shape and contoured surfaces for fitting against a palm and under fingers of a user's hand;
a track ball positioned at an end of said body and accessible by a thumb of said user's hand for controlling positioning of a cursor on the display;
a scroll knob positioned circumferentially of said track ball and accessible by said thumb for providing a scroll function on the display;
click buttons positioned on a surface of said body and accessible by fingers of said hand for providing right and left click functions;
a battery pack attached to said body for powering internal functions of the apparatus and comprising contoured surfaces for fitting in said hand and indicator lights for indicating an amount of charge in said battery pack; and
a glove attached to said body comprising a thumb hole, a fingers hole and an adjustable attachment means for adjustably attaching said glove to said user's hand, where when said user's hand is placed in said glove by placing said thumb in said thumb hole and said fingers through said fingers hole such that said body is retained against said palm, said track ball and scroll knob are easily accessible by said thumb, said click buttons are easily accessibly by said fingers, repetitive wrist motions are substantially eliminated and the apparatus is retained on said user's hand when said user's hand is used for key entry on the keyboard.

20. The apparatus as recited in claim 19, further comprising a base unit for charging said battery pack.
